(19) United States
(12) Patent Application Publication
(10) Pub. No.: US 2005/0236231 A1
(43) Pub. Date: Oct. 27, 2005

(54) Dental handpiece lubricating apparatus

(76) Inventor: Tom Fee, Weston, FL (US)

Correspondence Address: John H. Oltman;Oltman, Flynn & Kubler, 915 Middle River Drive #415, Fort Lauderdale, FL, 33304-3585, US

(21) Appl. No.: 11/111,610

(22) Filed: Apr. 21, 2005

Related U.S. Application Data
(63) Continuation-in-part of application No. 10/829,688, filed on Apr. 23, 2004.

(51) Int. Cl. F16N 7/34

(52) U.S. Cl. 184/55.2

(57) ABSTRACT

A cleaning and lubricating apparatus for a dental handpiece or other device includes a handpiece mounting base having a handpiece mounting structure; a lubricant reservoir; a compressed air chamber; a compressed air source connection structure in fluid communication with the compressed air chamber and with the lubricant reservoir; a valve pin and a valve pin slide passageway extending from a slide passageway opening in the mounting base to the air chamber and slidably containing the valve pin so that the valve pin has a valve pin exposed end extending outwardly from the mounting base and the valve pin a valve pin inward end and has a lateral lubricant delivery depression and is fitted with at least one sealing structure positioned at the point along the valve pin at which the slide passageway meets the air chamber; a lubricant deposit passageway extending between the lubricant reservoir and the slide passageway for delivering lubricant into the lubricant delivery depression.

This application is a continuation-in-part of application Ser. No. 10/829,688 filed on Apr. 23, 2004.

### BACKGROUND OF THE INVENTION

1. Field of the Invention

The present invention relates generally to the field of high speed pneumatic turbines and low speed pneumatically powered motors typically used in the dental and medical and in the carving and engraving professions, and to cleaning, lubricating and servicing of this equipment. More specifically the present invention relates to a pneumatic handpiece lubricating apparatus for lubricating and purging a handpiece, such as a dental handpiece, having a handpiece intake port opening into a handpiece intake line leading to a high speed turbine or a low speed motor and a handpiece exhaust port opening from a handpiece exhaust line leading away from the turbine or motor. The apparatus includes a handpiece mounting base having a handpiece mounting structure, a lubricant reservoir, a compressed air source connection structure including an air pressure regulator and connecting a compressed air supply line with a compressed air chamber in fluid communication with the lubricant reservoir, a valve pin slide passageway extending from the exterior of the mounting base to the air chamber and slidably containing a valve pin with a valve pin exposed end with a lateral lubricant delivery depression and with a first O-ring creating a seal between the valve pin and the slide passageway and a second O-ring spaced apart from the first O-ring and positioned to create a releasible seal where the slide passageway meets the air chamber, such that sliding the valve pin within the slide passageway toward the air chamber advances the second O-ring toward the air chamber to open fluid communication between the slide passageway and the air chamber, a lubricant deposit passageway extending between the lubricant reservoir and the slide passageway, a lubricant delivery passageway extending from the slide passageway between the first and second O-rings in their sealing position and into the handpiece mounting structure to be in fluid communication with the handpiece intake port and thus with the handpiece intake line. A third O-ring is provided to prevent lubricant from escaping from the apparatus through the slide passageway. The compressed air chamber preferably is placed in fluid communication with the lubricant reservoir through a compressed air delivery passageway. To operate the apparatus, the user mounts the base of a handpiece onto the handpiece mounting structure so that the handpiece intake port is in fluid communication with the lubricant delivery passageway. Then the user depresses the valve pin exposed end, which advances the lubricant delivery depression into alignment with the lubricant delivery passageway so that air and the second O-ring seal is moved and fluid communication between the air chamber and the slide passageway is opened, and air and a measured quantity of lubricant advances abruptly through the lubricant delivery passageway, the handpiece intake line and to the turbine. Any dirty lubricant within the turbine is sprayed both out of the turbine and through and out of the handpiece exhaust line. The apparatus or a variation of the apparatus may be used to apply flowable material other than lubricant to a handpiece, such as sterilizing fluid, steam or cryogenic material. The apparatus may be used for servicing devices other than dental handpieces, such as various motors and handpieces for other professions and purposes.

2. Description of the Prior Art

There have previously been cleaning and lubrication devices for dental handpieces. Problems with these prior devices have been that they do not deliver a properly measured quantity of lubricant to the handpiece turbine, operators commonly misapply lubricant to the exhaust hole of the handpiece, or the lubricant reaches the turbine in a clump or clot so that it does not effectively penetrate the bearings of high speed turbines or the rotor mechanism of low speed motors and it is not distributed evenly through the turbine for full lubrication. Another problem is that some of the lubricant exits the handpiece and is not contained, thereby contaminating the work area and possibly other instruments, and preventing reliable evaluation of expelled lubricant color necessary for determining if additional lubricant is needed. Other devices are commonly constructed with various hose tubing which bends, pinches or cracks. They employ inexpensive “miniature” regulators which fail or fall out of adjustment, all of which is detrimental to handpiece life and performance.

Prior handpiece servicing devices include the dental handpiece purging device of Wiltrout, et al., U.S. Pat. No. 5,282,745, issued on Feb. 1, 1994; the dental tool maintenance apparatus and method of De Rocchis, et al., U.S. Pat. No. 4,990,087, issued on Feb. 5, 1991; the dental hand piece lubricant dispenser of Brown, U.S. Pat. No. D460,187, issued on Jul. 9, 2002; the pneumatic tool lubrication system of Anspach, Jr. et al., U.S. Pat. No. 5,427,203, issued on Jun. 27, 1995; the contamination prevention device for ultra high speed dental type handpiece of Vogel, U.S. Pat. No. 6,146,137, issued on Nov. 14, 2000; the dental equipment cleaning device of Frank, et al., U.S. Pat. No. 5,281,139, issued on Jan. 25, 1994; the method and apparatus for lubricating and disinfecting dental drills of Hoffman, U.S. Pat. No. 5,165,503, issued on Nov. 24, 1992; the apparatus for cleaning and/or disinfecting dental handpieces in a dentist equipment of Rosander, U.S. Pat. No. 4,264,303, issued on Apr. 28, 1981; the disposable container for cleaning and lubricating a dental handpiece of Schneck, U.S. Pat. No. 5,350,064, issued on Sep. 27, 1994; the dental handpiece having cleaning unit of Kawata, U.S. Pat. No. 5,380,201, issued on Jan. 10, 1995; the dental instrument cover of Griffin, U.S. Pat. No. Des. 383,843, issued on Sep. 16, 1997; the lubricator of Oetting, et al., U.S. Pat. No. 5,123,504, issued on Jun. 23, 1992; the injection lubricating apparatus of Thrasher, Jr., U.S. Pat. No. 4,105,095, issued on Aug. 8, 1978; the air line oiler of Wells, U.S. Pat. No. 6,070,698, issued on Jun. 6, 2000; and the device for producing a lubricant mist in a compressed air line of Kuther, U.S. Pat. No. 6,328,227, issued on Dec. 11, 2001.

It is thus an object of the present invention to provide a dental handpiece lubricating apparatus which lubricates and then purges debris from the turbine or motor and thus increases the life of the handpiece turbine or motor by as much as fifty percent.

It is another object of the present invention to provide such a dental handpiece lubricating apparatus which is configured to connect directly to a conventional air delivery unit in a doctor's operatory so that the doctor can quickly lubricate the handpiece before an assistant removes it from the operating unit, which delivers air and lubricant at a pressure level which is adjustable so that the pressure is always correct, and which measures and delivers the appropriate amount of lubricant, normally in the form of oil, to the correct drive air line in a handpiece, avoiding the common mistake of placing oil in the wrong handpiece line either manually or with a purge station, and accomplishes this with only one moving part and no plastic hoses to crack or leak, so that the apparatus is not likely to fail.

It is still another object of the present invention to provide such a dental handpiece lubricating apparatus which atomizes the lubricant for complete and even lubrication of the handpiece turbine or motor, which provides one step activation for lubrication, purge and exhaust capture to prevent workplace contamination, and easy mounting and removal of a handpiece, and which thereby reduces time spent by dental office staff performing handpiece lubricating.

It is yet another object of the present invention to provide such a dental handpiece lubricating apparatus including a lubricant reservoir with a circumferential window for visual determination of the lubricant level so that a need for refilling can be recognized, exhaust cover and filter, has a small footprint and gives a professional look appropriate to a dental office environment.

It is a still further object of the present invention to provide such a dental handpiece lubricating apparatus which has an uninterrupted narrow profile or envelope for easy hand gripping and which has a transparent spray containment exhaust cover, through which the handpiece can be viewed during lubrication which is easily manually released by a tilting and removed for cleaning.

It is finally an object of the present invention to provide such a dental handpiece lubricating apparatus which captures and filters air exhausted from the handpiece exhaust line through a Hepa filter before entering the surrounding operator work area without the unsightly and inconvenient use of tubes and bottles, preventing exhausted air exiting through the head of the handpiece from leaking out of the apparatus and contaminating other instruments being cleaned and sterilized in the same work area, and which permits easy inspection of exhaust oil and debris so that a determination can be made of whether more lubrication is needed.

### SUMMARY OF THE INVENTION

The present invention accomplishes the above-stated objectives, as well as others, as may be determined by a fair reading and interpretation of the entire specification.

A dental handpiece lubricating apparatus is provided for purging and lubricating a handpiece having a handpiece intake port opening into a handpiece intake line leading to a handpiece turbine, the apparatus including a handpiece mounting base having a handpiece mounting structure; a lubricant reservoir; a compressed air chamber; a compressed air source connection structure in fluid communication with the compressed air chamber and with the lubricant reservoir; a valve pin and a valve pin slide passageway extending from a slide passageway opening in the mounting base to the air chamber and slidably containing the valve pin so that the valve pin has a valve pin exposed end extending outwardly from the mounting base and the valve pin a valve pin inward end and has a lateral lubricant delivery depression and is fitted with at least one sealing structure positioned at the point along the valve pin at which the slide passageway meets the air chamber; a lubricant deposit passageway extending between the lubricant reservoir and the slide passageway for delivering lubricant into the lubricant delivery depression; and a lubricant delivery passageway extending from the slide passageway into the handpiece mounting structure to be in fluid communication with the handpiece intake port and thus with the handpiece intake line; so that sliding the valve pin within the slide passageway toward the air chamber advances the at least one sealing structure toward the air chamber thereby opening fluid communication between the slide passageway and the air chamber.

The at least one sealing structure preferably includes a lubricant delivery passageway meeting the slide passageway. The dental handpiece lubricating apparatus preferably additionally includes a compressed air delivery passageway extending between the compressed air chamber and the lubricant reservoir, placing the compressed air chamber in fluid communication with the lubricant reservoir, where the compressed air chamber is placed in fluid communication with the lubricant reservoir through a compressed air delivery passageway. The lubricant reservoir preferably is annular to define a reservoir center post through which the lubricant delivery passageway axially extends. The dental handpiece lubricating apparatus preferably additionally includes a circumferential window defining a lubricant reservoir outer side wall, so that the level of lubricant within the lubricant reservoir can be viewed. The at least one sealing structure preferably includes at least one O-ring creating a seal between the slide passageway and the air chamber when the valve pin is in its biased position. The dental handpiece lubricating apparatus preferably additionally includes a spray containment enclosure sealingly secured to the mounting base surrounding the handpiece mounting structure and extending a sufficient distance from the handpiece mounting structure to contain a handpiece. The spray containment enclosure preferably includes an air release port fitted with a filter for removing lubricant from air released through the air release port. The filter optionally is a Hepa filter. The spray containment enclosure preferably includes a transparent tube having a tube mounted end removably and sealingly enclosing the handpiece mounting structure and having a tube free end removably fitted with a tube cap. The air release port preferably passes through the tube cap. The lubricant delivery depression preferably includes a circumferential groove around the valve pin, so that air can flow around the groove and gather any lubricant contained within the groove. The valve pin exposed end preferably includes a hand abutment disk for more widely distributing pressure of the valve pin against a user hand for greater comfort. The handpiece mounting structure optionally includes an air-oil atomizing screen and a female handpiece coupler. The air source connection structure preferably includes quick coupling connector and an air regulator.

An apparatus is further provided, including dental handpiece lubricating apparatus for purging and lubricating a handpiece having a handpiece intake port opening into a handpiece intake line leading to a handpiece turbine; a handpiece mounting base having a handpiece mounting structure; a lubricant reservoir; a compressed air chamber; a compressed air source connection structure in fluid communication with the compressed air chamber and with the lubricant reservoir; a valve pin and a valve pin slide passageway extending from a slide passageway opening in the mounting base to the air chamber and slidably containing the valve pin so that the valve pin has a valve pin exposed end extending outwardly from the mounting base and the valve pin has a valve pin inward end and has a lateral lubricant delivery depression and is fitted with a first O-ring and a second O-ring spaced apart from the first O-ring and positioned at the point along the valve pin at which the slide passageway meets the air chamber; a lubricant deposit passageway extending between the lubricant reservoir and the slide passageway for delivering lubricant into the lubricant delivery depression; and a lubricant delivery passageway extending from the slide passageway into the handpiece mounting structure to be in fluid communication with the handpiece intake port and thus with the handpiece intake line; so that sliding the valve pin within the slide passageway toward the air chamber advances the at least one sealing structure toward the air chamber thereby opening fluid communication between the slide passageway and the air chamber.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a cross-sectional side view of the first preferred embodiment of the present apparatus.

FIG. 2 is a close-up cross-sectional side view of the apparatus base of FIG. 1 showing the valve pin structure.

FIG. 3 is an enlarged view of the first preferred embodiment in its activated mode.

FIG. 4 is a cross-sectional side view of the second preferred embodiment of the present apparatus

FIG. 5 is a close-up cross-sectional side view of the apparatus base of FIG. 3 showing the valve pin structure.

FIG. 6 is a broken-away view of the enclosure tube mounted end and of the enclosure tube mount onto which it is fitted, illustrating the mount and inner tube beveled segments for tube dislodgement from the apparatus base.

FIG. 7 is a cross-sectional view of the enclosure tube mount and of one side of the enclosure tube in upright mounted position and also in tilted position for dislodgement from the mount and apparatus base.

FIG. 8 is a side view of the second embodiment of the apparatus showing the enclosure tube tilted on the enclosure tube mount for dislodgement.

FIG. 9 is a broken away cross-sectional view of the enclosure tube free end and tube cap, showing the cap and inner tube free end beveled segments for cap dislodgement from the enclosure tube.

FIG. 10 is a side view of the second embodiment of the apparatus showing the tube cap prior to tilting in enclosure tube for cap dislodgement from the enclosure tube.

FIG. 10a is a broken-away, close-up view of the enclosure tube free end as in FIG. 10, but with the tube cap tilted for dislodgement from the enclosure tube.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

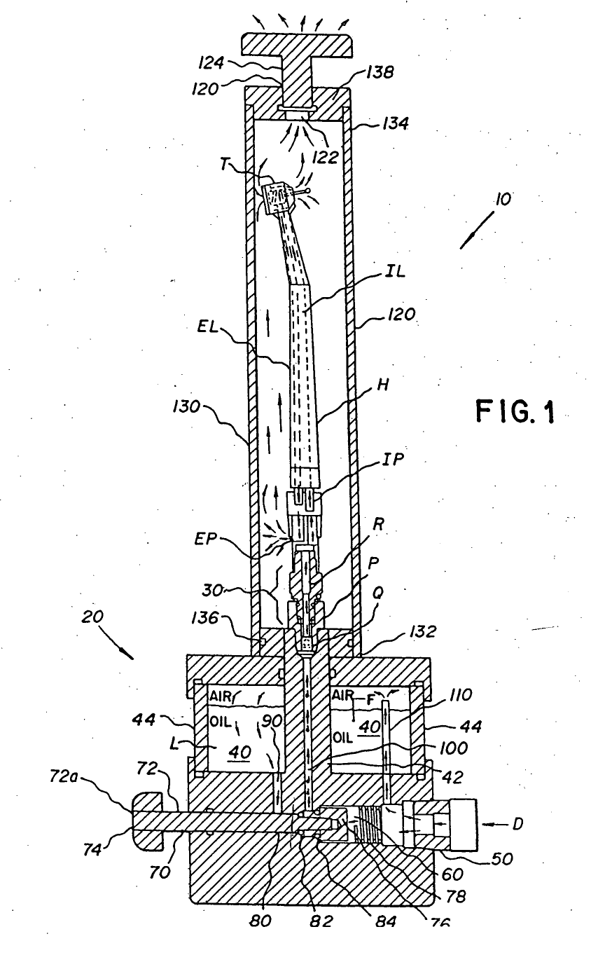

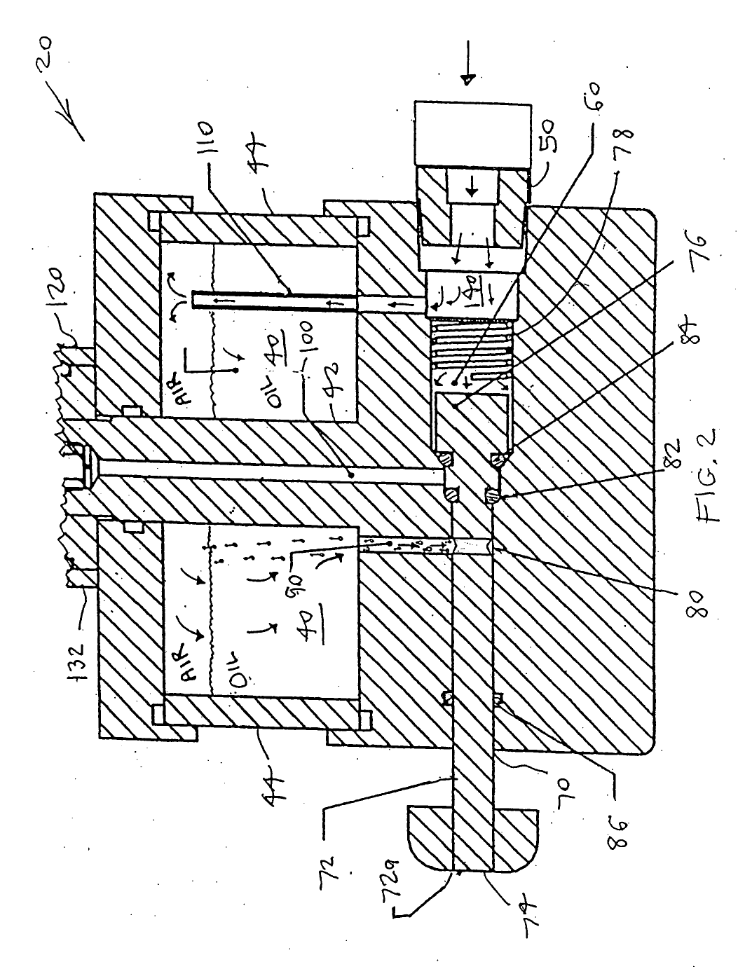

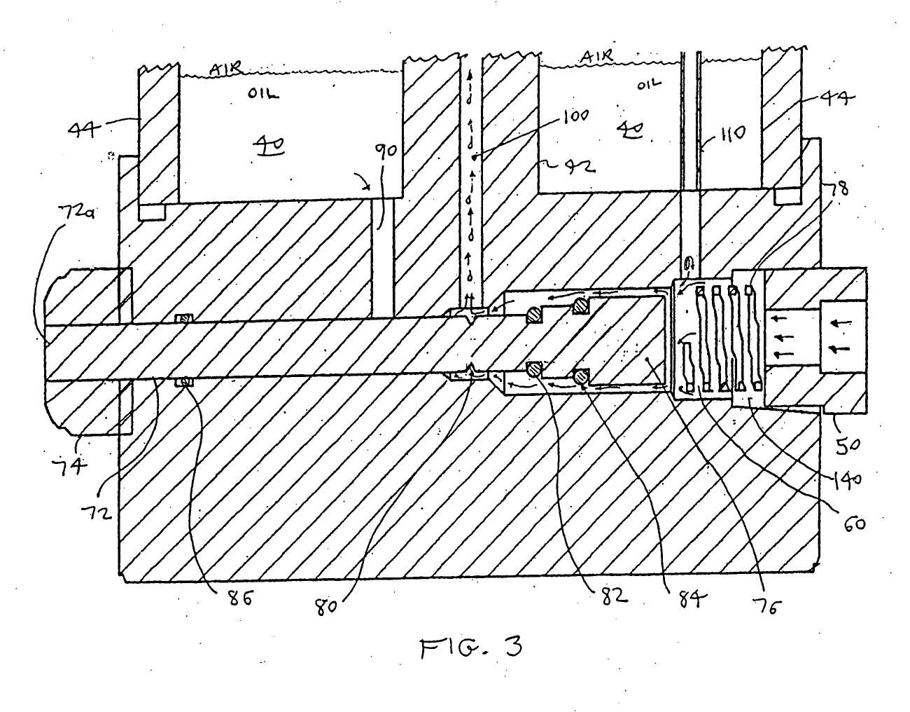

Referring to FIGS. 1-3, a dental handpiece lubricating apparatus 10 for cleaning a handpiece having a handpiece H intake port IP opening into a handpiece intake line IL leading to a handpiece turbine T and a handpiece exhaust port EP opening from a handpiece exhaust line EL leading away from the turbine T is disclosed. Apparatus 10 includes a handpiece mounting base 20 having a handpiece mounting structure 30, a lubricant reservoir 40, a compressed air source connection structure 50 in fluid communication with a compressed air supply line with a compressed air chamber 60 and with the lubricant reservoir 40, a valve pin slide passageway 70 extending from the exterior of the mounting base 20 to the air chamber 60 and slidably containing a valve pin 72 with a valve pin exposed end 74 and an valve pin inward end 76 and with a lateral lubricant delivery depression 80 and with a first O-ring 82 creating a seal between the valve pin 72 and the slide passageway 70 and a second O-ring 84 spaced apart from the and positioned to create a releasible seal where the slide passageway 70 meets the air chamber 60 so that sliding the valve pin 72 within the slide passageway 70 toward the air chamber 60 advances the second O-ring 84 toward the air chamber to open fluid communication between the slide passageway 70 and the air chamber 60, a lubricant deposit passageway 90 extending between the lubricant reservoir 40 and the slide passageway 70, and extending from the slide passageway 70 between the first and second O-rings 82 and 84, respectively, in their sealing position into the handpiece mounting structure 30 to be in fluid communication with the handpiece intake port IP and thus with the handpiece intake line IL. A third O-ring 86 prevents lubricant L from escaping through the slide passageway 70. The compressed air chamber 60 preferably is placed in fluid communication with the lubricant reservoir 40 through a compressed air delivery passageway 110, preferably including a tube extending upwardly into the lubricant reservoir 40 to a point above the level of the lubricant in the lubricant reservoir 40. Compressed air source connection structure 50 preferably mounts an air pressure regulator (not shown) to regulate the air pressure within the air chamber 60.

To operate apparatus 10, the user mounts the base of a handpiece H onto the handpiece mounting structure 30 so that the handpiece intake port IP is in fluid communication with the air-lubricant delivery passageway 100. Then the user depresses the valve pin exposed end 74, which advances the lubricant delivery depression 80 into alignment with the air-lubricant delivery passageway 100 so that the second O-ring seal 84 is moved and fluid communication between the air chamber 60 and the slide passageway 70 is opened, and air and a measured quantity of lubricant advances abruptly through the air-lubricant delivery passageway 100, the handpiece intake line IL and to the turbine T. Any dirty lubricant within the turbine T is sprayed both out of the turbine T and through and out of the handpiece exhaust line EL. After the initial blast of lubricant L, the handpiece H is purged as the button 72a remains depressed. All of this happens in approximately five seconds.

The lubricant reservoir 40 preferably is annular to define a reservoir center post 42 through which the air-lubricant delivery passageway 100 axially extends. A circumferential window 44 preferably forms a lubricant reservoir outer side wall so that the lubricant level within the reservoir 40 can be monitored. Incoming air pressure returns the valve pin 72 to a position within the slide passageway 70 at which the lubricant delivery depression 100 is adjacent to and aligned with the lubricant deposit passageway 90. The valve pin 72 optionally is biased by a coil valve pin spring 78 located inside the air chamber 60 and bearing against the chamber 60 end wall and against the valve pin inward end 76 to return the valve pin 72 when the apparatus 10 is disconnected from the air source and no pressurized air is present to do so. A spring retaining projection P having a screwdriver slot S preferably protrudes from the valve pin inward end 76 into spring 78. The screw driver slot S permits pin 72 rotation with a screwdriver to tighten or loosen the valve button 72a at the other pin end 74. During typical apparatus 10 operation, spring 78 serves no purpose.

A spray containment enclosure 120 preferably is sealingly secured sealingly over an enclosure tube mount 32 protruding upwardly from the top of the mounting base 20 having a circumferential channel 38 fitted with a sealing O-ring 136, so that the spray containment enclosure 120 surrounds the handpiece mounting structure 30 and extends upwardly a sufficient distance to contain an entire handpiece H. The spray containment enclosure 120 preferably includes an air release port 122 fitted with a filter 124 for removing lubricant from released air. The filter 124 preferably is a Hepa filter. The spray containment enclosure 120 preferably includes a transparent tube 130 having a tube mounted end 132 removably and sealingly fitted around or equivalently to the handpiece mounting structure 30 with an internal tube O-ring 136, and having a tube free end 134 removably fitted with a tube cap 138 also removably secured in a snap-in sealing relation to the tube free end 134 with an O-ring, and the air release port 122 preferably passes through the tube cap 138. O-ring 136 not only creates a seal but also aligns and removably secures the tube mounted end 132 to the handpiece mounting structure 30. O-ring 136 gently snaps on and off mounting structure 30. The lubricant delivery depression 100 preferably is a circumferential groove around the valve pin 72, so that air can flow around the groove and gather any lubricant within the depression 80. The depression 80 can take many forms, such as a narrow circumferential groove or a wide and preferably shallow circumferential channel. In fact, the depression 80 may be simply a lubricant gathering area 80 where the pin itself gathers and clings to enough lubricant L. The valve pin exposed end 74 preferably includes a hand abutment disk 72a to more widely distribute the pressure of the valve pin 72 against the user thumb for greater comfort.

The handpiece mounting structure 30 can optionally include an air-oil atomizing screen O, although this is not needed because atomization takes place in the turbulence of the air-lubricant mixing chamber 140. The difference in size between valve pin inward end 76 and compressed air chamber 60 creates a clear passageway that is slightly less in surface area than the IP-H intake port of the handpiece H. This creates a positive air flow throughout the system which helps to atomize through turbulence and prevents development of dead air space.

Handpiece mounting structure 30 preferably includes a female handpiece coupler P which connects to a male handpiece coupler R. An air drive line Q is provided. One preferred female handpiece coupler P preferably is catalog number MC1002 manufactured by COLDER PRODUCTS™., although many other couplers P are contemplated. The preferred air drive line Q is pipe thread catalog number MC2402 also manufactured by COLDER PRODUCTS™. The compressed air source connection structure 50 preferably includes a quick coupler connector and an air pressure regulator. The air supply is provided through a regulator which is pre-set to produce 30 psi at the handpiece H. The regulator is not adjustable and is tamper-proof to prevent operators from adjusting the device out of the optimum range. These elements preferably include a check valve.

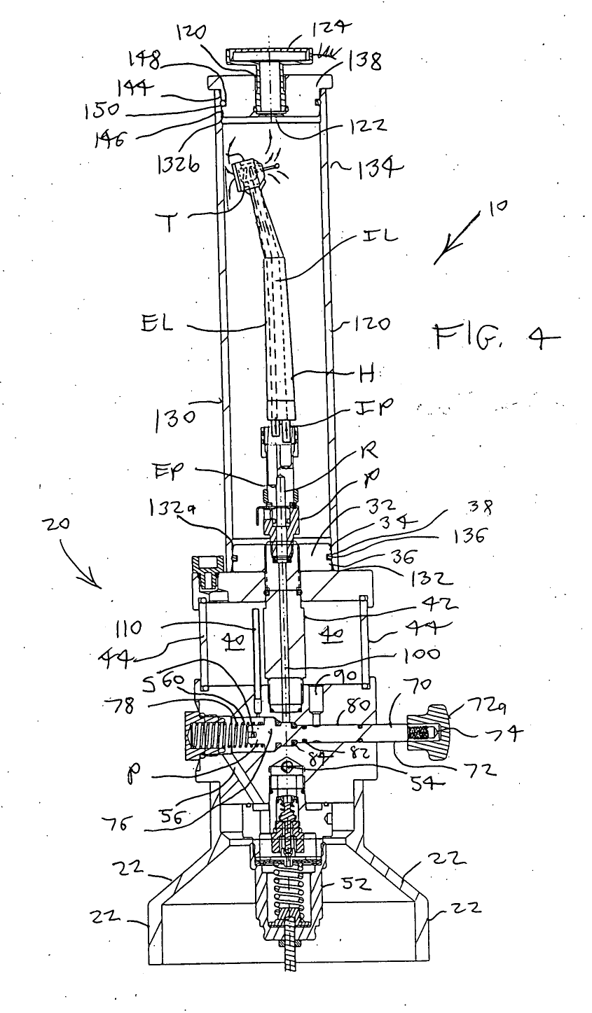

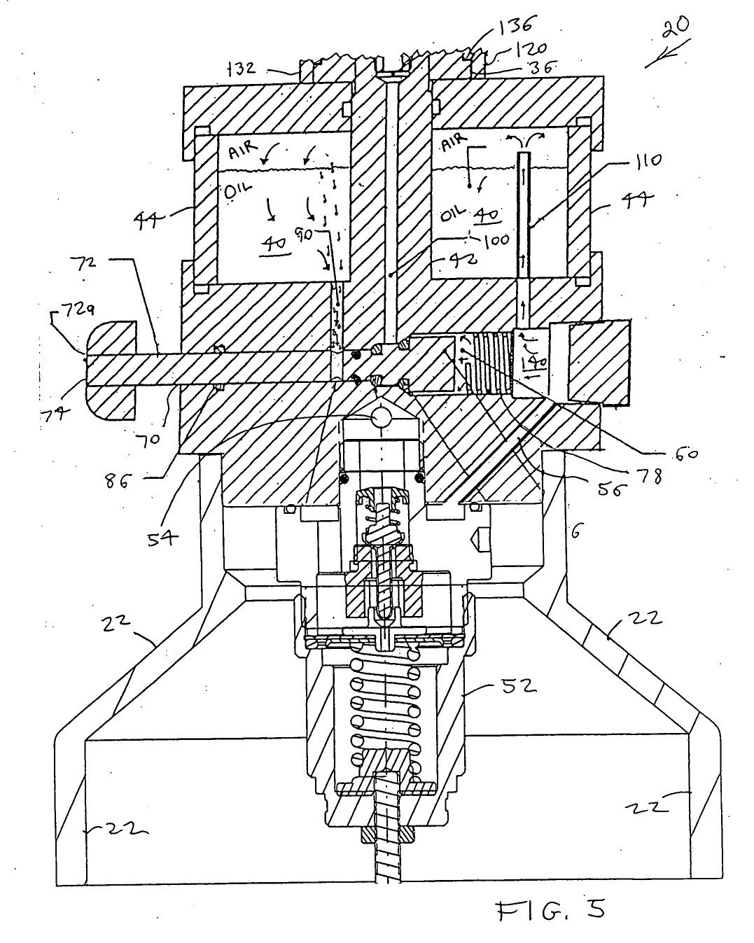

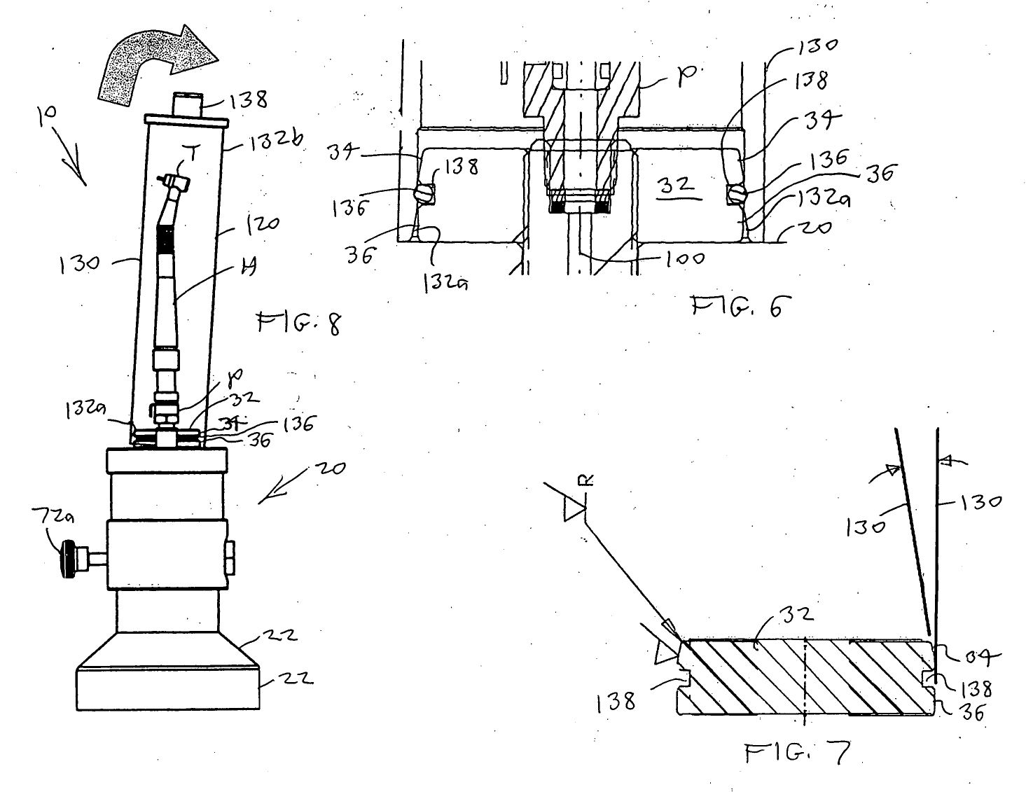

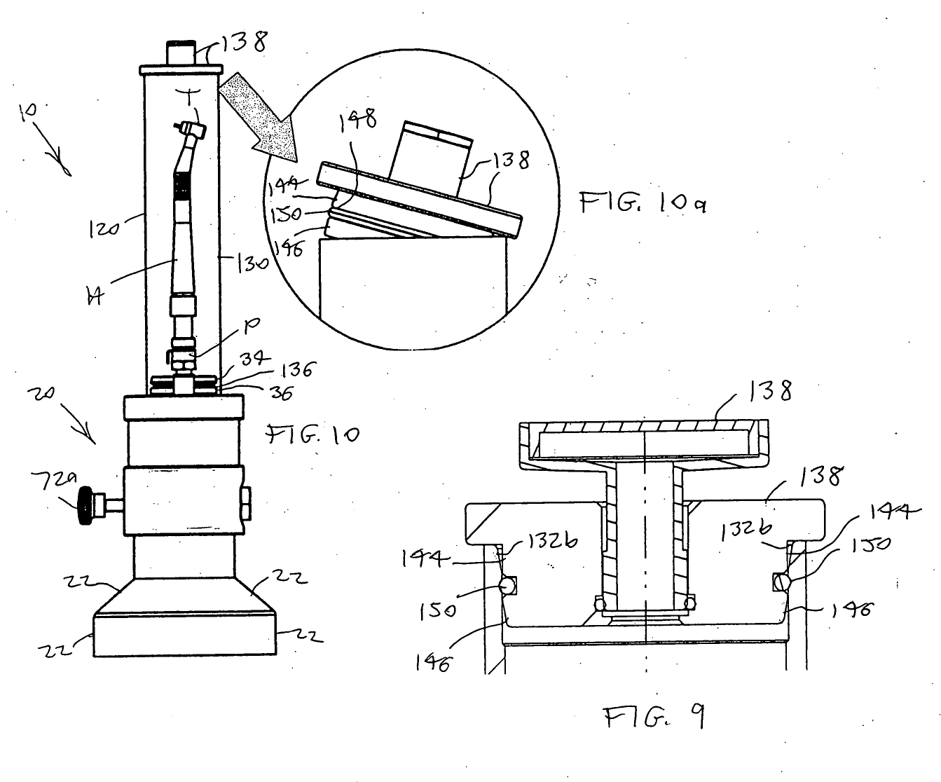

Second Preferred Embodiment A second embodiment of apparatus 10 is substantially like the first embodiment, except that the air pressure regulator 52 is integrated into the bottom of the handpiece mounting base 20 and receives compressed air through a compressed air passageway 54 extending from an upright side of the mounting base 20 radially into the base 20. Air leaves the regulator 52 and to the air chamber 60 through a regulated air delivery passageway 56 in the base 20. See FIGS. 4-5. A support skirt 22 extends downwardly from the perimeter of mounting base 20 to a distance below the lower end of regulator 52 to rest on a support surface. This arrangement permits a user to hand grip the base 20 without splitting fingers to fit around a laterally protruding regulator 52. Air pressure regulator 52 limits air pressure within the air chamber 60 to a preferred pressure of 40 pounds per square inch (psi).

The spray containment enclosure 120 differs from that illustrated for the first embodiment in that the enclosure tube mount 32 includes upper and lower lateral mount beveled segments 34 and 36 separated by the circumferential channel 38 fitted with sealing O-ring 136. Enclosure tube mounted end 132 preferably includes an internal tube mounted end beveled segment 132a. See FIGS. 6-8. Mount beveled segments 34 and 36 and internal tube mounted end beveled segment 132a permit enclosure tube 130 to be manually tilted relative to mounting base 20 and thereby more easily dislodged and removed from base 20. The bevel angles relative to the tube 130 longitudinal axis are all preferably ten degrees. These angles may vary according to the diameter of the clear tube 130 and still be effective.

The tube cap 138 preferably also has tube upper and lower beveled segments 144 and 146 separated by a circumferential channel 148 fitted with sealing O-ring 150, and an internal tube free end beveled segment 132b is provided on the tube cap 138 so that tube cap 138 can be tilted and dislodged for easier enclosure tube 130 removal. See FIGS. 9-10a. It is contemplated that these enclosure mount 32, tube cap 138 and tube 130 configurations be provided on the first embodiment as well, and on other possible embodiments of apparatus 10.

### Apparatus Operation

Static pressurization occurs when the apparatus 10 is initially connected to an air supply source. After each activation the air chamber 60 re-pressurizes to a static pressurized condition. While in this static pressurized state, air travels through air source connection structure 50 and air delivery passageway 110 and pressurizes the lubricant reservoir 40. The pressurized lubricant then travels through the lubricant deposit passageway 90. The lubricant delivery depression 80 is machined into valve pin 72 to accept the recommended quantity of lubricant preferably in the form of three drops of oil. Once again, the depression 80 can take many forms, such as a narrow circumferential groove or a wide and preferably shallow circumferential channel. The lubricant delivery depression 80 fills with oil which is ready to be delivered.

The shallow radial groove of depression 80 provides a loop around which air rises upwardly around the valve pin 72 circumference under pressure from the air source, purging air from the depression 80 as it rises upward into the lubricant reservoir 40. This provides a consistent oil supply to the depression 80 as the system returns to a static pressurized state.

This looping of air through the lubricant delivery depression 80 occurs when the system is de-activated and the valve button 72a returns to its closed position. Air is re-introduced to the lubricant delivery depression 80 groove and looping re-occurs as the system returns to its static pressurized state. The depression 80 is again filled with oil and ready to be delivered to the air-lubricant delivery passageway 100 upon activation of the valve button 72a.

Upon activation by pressing the valve pin exposed end 74 inwardly, the air and oil mixture advances to and through the turbine T of the handpiece H providing the needed oil lubrication and subsequent purging of oil and debris in the turbine T chamber of the handpiece H. The exhausted air mix (including air/oil and debris from the turbine T chamber) then enters the handpiece exhaust line HL and is channeled into spray containment enclosure 120. Exhaust air coming from handpiece turbine T out of the head of the handpiece H, as well as from the handpiece exhaust tube (not shown) are captured in the spray containment enclosure 120 and then filtered through the hepa filter 124, capturing the contaminated oil and debris in the transparent tube 130 where it can be visually inspected by the operator.

Apparatus 10 may be used for servicing devices other than dental handpieces, such as various motors and handpieces for other professions and purposes. And apparatus 10 or a variation of apparatus 10 may be used to apply flowable material other than lubricant to a handpiece or motor, such as sterilizing fluid, cryogenic material, or steam. For cryogenic or sterilizing fluid, a continuous flow of these materials rather than a burst of lubricant is provided.

While the invention has been described, disclosed, illustrated and shown in various terms or certain embodiments or modifications which it has assumed in practice, the scope of the invention is not intended to be, nor should it be deemed to be, limited thereby and so other modifications or embodiments as may be suggested by the teachings herein are particularly reserved especially as they fall within the breadth and scope of the claims here appended.

1. A dental handpiece lubricating apparatus for purging and lubricating a handpiece having a handpiece intake port opening into a handpiece intake line leading to a handpiece turbine, the apparatus comprising:
a handpiece mounting base having a handpiece mounting structure;
a lubricant reservoir;
a compressed air chamber;
a compressed air source connection structure in fluid communication with said compressed air chamber and with said lubricant reservoir;
a valve pin and a valve pin slide passageway extending from a slide passageway opening in said mounting base to said air chamber and slidably containing said valve pin such that said valve pin has a valve pin exposed end extending outwardly from said mounting base and said valve pin a valve pin inward end and has a lateral lubricant delivery depression and is fitted with at least one sealing structure positioned at the point along said valve pin at which said slide passageway meets said air chamber;
a lubricant deposit passageway extending between said lubricant reservoir and said slide passageway for delivering lubricant into said lubricant delivery depression;
and an air-lubricant delivery passageway extending from said slide passageway into said handpiece mounting structure to be in fluid communication with the handpiece intake port and thus with the handpiece intake line;
such that sliding said valve pin within said slide passageway toward said air chamber advances said at least one sealing structure toward said air chamber thereby opening fluid communication between said slide passageway and said air chamber.

2. The dental handpiece lubricating apparatus of claim 1, wherein said at least one sealing structure comprises a air-lubricant delivery passageway meeting said slide passageway.

3. The dental handpiece lubricating apparatus of claim 1, additionally comprising a compressed air delivery passageway extending between said compressed air chamber and said lubricant reservoir, placing said compressed air chamber in fluid communication with said lubricant reservoir, wherein said compressed air chamber is placed in fluid communication with the lubricant reservoir through a compressed air delivery passageway.

4. The dental handpiece lubricating apparatus of claim 1, wherein said lubricant reservoir is annular to define a reservoir center post through which said air-lubricant delivery passageway axially extends.

5. The dental handpiece lubricating apparatus of claim 1, additionally comprising a circumferential window defining a lubricant reservoir outer side wall, such that the level of lubricant within said lubricant reservoir can be viewed.

6. The dental handpiece lubricating apparatus of claim 1, additionally comprising a valve pin spring biasing said valve pin inwardly relative to said mounting base.

7. The dental handpiece lubricating apparatus of claim 6, wherein said at least one sealing structure comprises at least one O-ring creating a seal between said slide passageway and said air chamber when said valve pin is in its biased position.

8. The dental handpiece lubricating apparatus of claim 6, wherein said valve pin spring is a coil spring and is located inside said air chamber and bears against a chamber wall and against said valve pin inward end.

9. The dental handpiece lubricating apparatus of claim 1, additionally comprising a spray containment enclosure sealingly secured to said mounting base surrounding said handpiece mounting structure and extending a sufficient distance from said handpiece mounting structure to contain a handpiece.

10. The dental handpiece lubricating apparatus of claim 9, wherein said spray containment enclosure comprises an air release port fitted with a filter for removing lubricant from air released through said air release port.

11. The dental handpiece lubricating apparatus of claim 10, wherein said filter is a Hepa filter.

12. The dental handpiece lubricating apparatus of claim 9, wherein said spray containment enclosure comprises an enclosure tube mount and a transparent tube having a tube mounted end removably and sealingly mounted to said enclosure tube mount and enclosing said handpiece mounting structure and having a tube free end removably fitted with a tube cap.

13. The dental handpiece lubricating apparatus of claim 12, wherein said air release port passes through said tube cap.

14. The dental handpiece lubricating apparatus of claim 1, wherein said lubricant delivery depression comprises a circumferential groove around said valve pin, such that air can flow around said groove and gather any lubricant contained within said groove.

15. The dental handpiece lubricating apparatus of claim 12, wherein said enclosure tube mount comprises upper and lower lateral mount beveled segments separated by a circumferential channel fitted with a sealing O-ring, and wherein said enclosure tube mounted end comprises an internal mounted end tube beveled segment, such that said enclosure tube can be manually tilted relative to said mounting base and thereby dislodged and removed from said enclosure tube mount and thereby from said mounting base.

16. The dental handpiece lubricating apparatus of claim 1, wherein said handpiece mounting structure comprises an air-oil atomizing screen and a female handpiece coupler.

17. The dental handpiece lubricating apparatus of claim 1, wherein said compressed air source connection means comprises quick coupling connector and an air regulator.

19. An apparatus, comprising:
dental handpiece lubricating apparatus for cleaning a handpiece having a handpiece intake port opening into a handpiece intake line leading to a handpiece turbine;
a handpiece mounting base having a handpiece mounting structure;
a lubricant reservoir;
a compressed air chamber;
a compressed air source connection structure in fluid communication with said compressed air chamber and with said lubricant reservoir;
a valve pin and a valve pin slide passageway extending from a slide passageway opening in said mounting base to said air chamber and slidably containing said valve pin such that said valve pin has a valve pin exposed end extending outwardly from said mounting base and said valve pin has a valve pin inward end and has a lateral lubricant delivery depression and is fitted with a first O-ring and a second O-ring spaced apart from the first O-ring and positioned at the point along said valve pin at which said slide passageway meets said air chamber;
a lubricant deposit passageway extending between said lubricant reservoir and said slide passageway for delivering lubricant into said lubricant delivery depression;
and an air-lubricant delivery passageway extending from said slide passageway into said handpiece mounting structure to be in fluid communication with the handpiece intake port and thus with the handpiece intake line;
such that sliding said valve pin within said slide passageway toward said air chamber advances said at least one sealing structure toward said air chamber thereby opening fluid communication between said slide passageway and said air chamber.

20. The dental handpiece lubricating apparatus of claim 19, wherein said at least one sealing structure comprises an air-lubricant delivery passageway meeting said slide passageway between said first O-ring and said second O-ring in their sealing position.

21. An apparatus for cleaning a device having a device intake port opening into a device intake line leading to a device rotational element, the apparatus comprising:
a device mounting base having a device mounting structure;
a flowable material reservoir;
a compressed air chamber;
a compressed air source connection structure in fluid communication with said compressed air chamber and with said flowable material reservoir;
a valve pin and a valve pin slide passageway extending from a slide passageway opening in said mounting base to said air chamber and slidably containing said valve pin such that said valve pin has a valve pin exposed end extending outwardly from said mounting base and said valve pin a valve pin inward end and has one of a lateral flowable material receiving depression and flowable material gathering area, and is fitted with at least one sealing structure positioned at the point along said valve pin at which said slide passageway meets said air chamber;
a flowable material deposit passageway extending between said flowable material reservoir and said slide passageway for delivering flowable material into one of: said flowable material delivery depression and flowable material gathering area;
and an air-flowable material delivery passageway extending from said slide passageway into said device mounting structure to be in fluid communication with the device intake port and thus with the device intake line;
such that sliding said valve pin within said slide passageway toward said air chamber advances said at least one sealing structure toward said air chamber thereby opening fluid communication between said slide passageway and said air chamber.

22. The apparatus of claim 21, wherein the device is a handpiece.

23. The apparatus of claim 21, wherein the device is a dental handpiece.

24. The apparatus of claim 21, wherein the device rotational element is a turbine.

25. The apparatus of claim 21, wherein the flowable material is a lubricant.

26. A handpiece lubricating apparatus for purging and lubricating a handpiece having a handpiece intake port opening into a handpiece intake line leading to a handpiece turbine, the apparatus comprising:
a handpiece mounting base having a handpiece mounting structure;
a lubricant reservoir;
a compressed air chamber;
a compressed air source connection structure in fluid communication with said compressed air chamber and with said lubricant reservoir;
a valve pin and a valve pin slide passageway extending from a slide passageway opening in said mounting base to said air chamber and slidably containing said valve pin such that said valve pin has a valve pin exposed end extending outwardly from said mounting base and said valve pin a valve pin inward end and has a lateral lubricant gathering area and is fitted with at least one sealing structure positioned at the point along said valve pin at which said slide passageway meets said air chamber;
a lubricant deposit passageway extending between said lubricant reservoir and said slide passageway for delivering lubricant onto said lubricant gathering area;
and an air-lubricant delivery passageway extending from said slide passageway into said handpiece mounting structure to be in fluid communication with the handpiece intake port and thus with the handpiece intake line;
such that sliding said valve pin within said slide passageway toward said air chamber advances said at least one sealing structure toward said air chamber thereby opening fluid communication between said slide passageway and said air chamber.

27. An apparatus, comprising:
dental handpiece lubricating apparatus for cleaning a handpiece having a handpiece intake port opening into a handpiece intake line leading to a handpiece turbine;
a handpiece mounting base having a handpiece mounting structure;
a lubricant reservoir;
a compressed air chamber;
a compressed air source connection structure in fluid communication with said compressed air chamber and with said lubricant reservoir;
lubricant delivery valve means in fluid communication with said compressed air source and said lubricant reservoir;
and an air-lubricant delivery passageway extending from said lubricant delivery valve means into said handpiece mounting structure to be in fluid communication with the handpiece intake port and thus with the handpiece intake line;
such that operating said lubricant delivery valve means releases compressed air to deliver a quantity of lubricant from said lubricant reservoir into said handpiece.

28. The dental handpiece lubricating apparatus of claim 26, additionally comprising a spray containment enclosure sealingly secured to said mounting base surrounding said handpiece mounting structure and extending a sufficient distance from said handpiece mounting structure to contain a handpiece.

29. The dental handpiece lubricating apparatus of claim 28, wherein said spray containment enclosure comprises an enclosure tube mount and a transparent tube having a tube mounted end removably and sealingly mounted to said enclosure tube mount and enclosing said handpiece mounting structure and having a tube free end removably fitted with a tube cap.

30. The dental handpiece lubricating apparatus of claim 29, wherein said enclosure tube mount comprises upper and lower lateral mount beveled segments separated by a circumferential channel fitted with a sealing O-ring, and wherein said enclosure tube mounted end comprises an internal mounted end tube beveled segment, such that said enclosure tube can be manually tilted relative to said mounting base and thereby dislodged and removed from said enclosure tube mount and thereby from said mounting base.
